(19) United States
(12) Patent Application Publication
(10) Pub. No.: US 2007/0245155 A1
(43) Pub. Date: Oct. 18, 2007

(54) Information processing apparatus having a user authentication function

(76) Inventors: Masahiro Mimura, Kawasaki (JP); Kenta Takahashi, Kawasaki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/641,762

(22) Filed: Dec. 20, 2006

(30) Foreign Application Priority Data
Dec. 22, 2005 (JP) 2005-369021

(51) Int. Cl. H04L 9/32

(52) U.S. Cl. 713/186

(57) ABSTRACT

Secret information only a user can know is encrypted and a decryption key is stored in a biometric information sensor. The biometric information sensor has a secret information decryption unit, a secret information display unit for presenting the secret information to the user, a biometric information detection unit for detecting that biometric information is presented to a biometric information input unit, and an alarm notice unit for issuing an alarm to the user if the biometric information is detected before the secret information is presented.

### INCORPORATION BY REFERENCE

The present application claims priority from Japanese application JP2005-369021 filed on Dec. 22, 2005, the content of which is hereby incorporated by reference into this application.

### BACKGROUND OF THE INVENTION

1. Field of the Invention

The present invention relates to an apparatus and method for providing a user authentication function, and more particularly to an apparatus and method applicable to access management of an information system for providing services only to users registered beforehand, user confirmation when services with toll are supplied, entrance/exit management for important facilities and rooms, and the like.

2. Description of the Related Art

In biometric authentication, biometric information of a user has the same function as that of a key of cryptography. It is therefore necessary in terms of security to prevent leak of biometric information or illegal acquisition thereof by an attacker. Leak of biometric information is generally protected by encryption of biometric information or the like. However, if forgery of a biometric authentication system itself is made by an attacker and if a user not knowing forgery enters biometric information, there is a risk that the attacker acquires illegally the biometric information of the user.

In order to address this issue, it is necessary that users can confirm by themselves validity of a biometric authentication system, particularly a sensor unit for entering biometric information. Although techniques of allowing users to confirm validity of a sensor unit for entering biometric information are still not disclosed, related techniques are disclosed in JP-A-2005-92697 and JP-A-2005-92788.

JP-A-2005-92697 describes techniques of preventing unauthorized authentication by a third party, in which at least one cipher only a user can understand is defined for biometric information, a randomly selected cipher is presented to the user, biometric information corresponding to the cipher is acquired from the user, and the biometric information corresponding to the cipher is compared with the biometric information acquired from the user. Namely, JP-A-2005-92697 aims to prevent impersonation through forgery of biometric information and discloses techniques of entering secret information only a user can know and entering biometric information of the user both of which are performed at the same time. Resistance against impersonation can therefore be improved more than the case authentication is performed only by biometric information.

JP-A-2005-92788 discloses techniques in which an IC card confirms validity of an IC card reader/writer and a confirmation result is notified to a user from an IC card issue unit. It is therefore possible to prevent a user from entering user confirmation information such as a password into an IC card reader/writer forged by an attacker.

However, in the case of JP-A-2005-92697, even if an attacker forges a sensor unit to illegally acquire input biometric information, there is a fear that secret information stored in the system is presented to the user to urge the user enter biometric information. If a biometric authentication system is forged by an attacker, there is a fear that a user erroneously enters biometric information before secret information is presented.

In the case of JP-A-2005-92788, it is essential to use an IC card because the IC card authenticates the IC card reader/writer.

### SUMMARY OF THE INVENTION

It is an object of the present invention to provide an apparatus and method capable of, without using an IC card, suppressing theft and appropriation of authentication information of a user by a third party through forgery of the apparatus.

In a biometric information illegal acquisition preventing method and apparatus of the present invention, secret information is encrypted and a decryption key is stored in a sensor unit. The sensor unit has a secret information decryption unit and a unit for presenting the decrypted secret information to a user. The sensor unit further includes a unit for detecting that biometric information is presented to a biometric information input unit and a unit for issuing an alarm to the user if the biometric information is presented before the secret information is presented.

According to the present invention, it is possible to obtain the advantages of, without using an IC card, suppressing theft and appropriation of authentication information of a user by a third party through forgery of the apparatus. Specifically, according to the present invention, since the sensor unit has a decryption key for decrypting secret information, there is an advantage that a user can confirm validity of the sensor unit so that even if the sensor unit itself is forged by an attacker, the secret information of the user cannot be displayed correctly. Another advantage is that since an alarm is issued to the user if a user presents biometric information before the biometric authentication system presents secret information, it is possible to suppress the user from inadvertently presenting the biometric information to the forged sensor unit. Still another advantage is that since the secret information validity verification unit is provided and secret information is presented only when validity of the secret information is confirmed, it is possible to suppress the user from inadvertently confirming false secret information as the user's secret information and presenting biometric information.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram showing an example of the configuration of a biometric authentication system according to an embodiment of the present invention.

FIG. 2 is a flow chart illustrating an operation of a biometric authentication sensor unit of the system according to the embodiment of the present invention.

FIG. 3 is a diagram showing the structure of secret information according to the embodiment of the present invention.

### DESCRIPTION OF THE EMBODIMENT

Description will now be made on an embodiment by illustratively using a biometric authentication system constituted of a personal computer (PC) and a biometric information sensor externally mounted on PC.

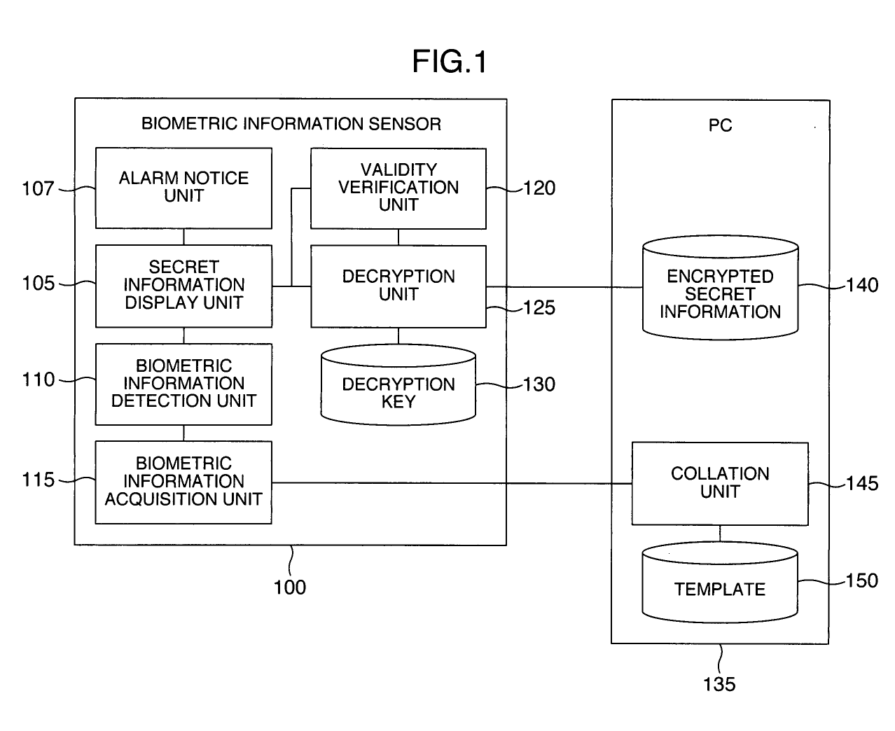

FIG. 1 shows the configuration of a biometric authentication system according to the embodiment of the present invention. The biometric authentication system includes a biometric information sensor (input device) 100 for acquiring biometric information presented by a user and a PC 135 for authenticating the user in accordance with the biometric information obtained by the biometric information sensor. The configuration of the present invention is not limited only to that shown in FIG. 1.

The biometric information sensor 100 is constituted of: a biometric information acquisition unit (e.g., microcomputer) 115 for converting biometric information presented by a user into electronic data or image data; a biometric information detection unit (e.g., a scanner) 110 for detecting that a user presents biometric information to the biometric information acquisition unit 115; a decryption unit (e.g., a co-processor) 125 for decrypting encoded secret information; a decryption key 130 to be used as a key for decryption; a validity verification unit (e.g., microcomputer) 120 for verifying validity of secret information; a secret information display unit (e.g., LEDs) 105 for displaying secret key to a user when validity of the secret key is verified; and an alarm notice unit (e.g., a speaker) 107 for issuing an alarm to a user when biometric information is detected before the secret information is presented. The decryption key 130 is stored in a storage unit (e.g., an EEPROM). In this embodiment, the secret information display unit 105 can turn on and off a plurality of colors (e.g., three colors) during a desired time period, by way of example and not limitative. For example, the secret information display unit 105 may display a plurality of marks. Instead of the secret information display unit 105, an output unit for outputting a plurality of sounds (melody) or an output unit for outputting a plurality of vibrations may also be used. In this embodiment, the alarm notice unit 107 issues an alarm sound, by way of example and not limitative. The alarm notice unit 107 may be a luminescent member. The decryption unit 125 and the validity verification unit 120 have higher tamper resistance than other units.

PC 135 is preferably constituted of a processor, an input unit, a display unit, a storage unit, a memory and a bus interconnecting these components. PC 135 may further include a communication unit. PC 135 has: encrypted secret information 140 obtained by encrypting secret information only a user can know; templates 150 which are biometric information of users registered beforehand; and a collation unit (processor) 145 for collating biometric information of a user acquired by the biometric information sensor 100 with templates. The encrypted secret information 140 and templates 150 are stored in the storage unit (e.g., a hard disk). It is preferable that biometric information of each user is registered beforehand by the user. The secret information of a user may be registered beforehand by the user or it may be generated by PC 135, presented to the user and registered. The template 150 preferably holds biometric information for each user ID.

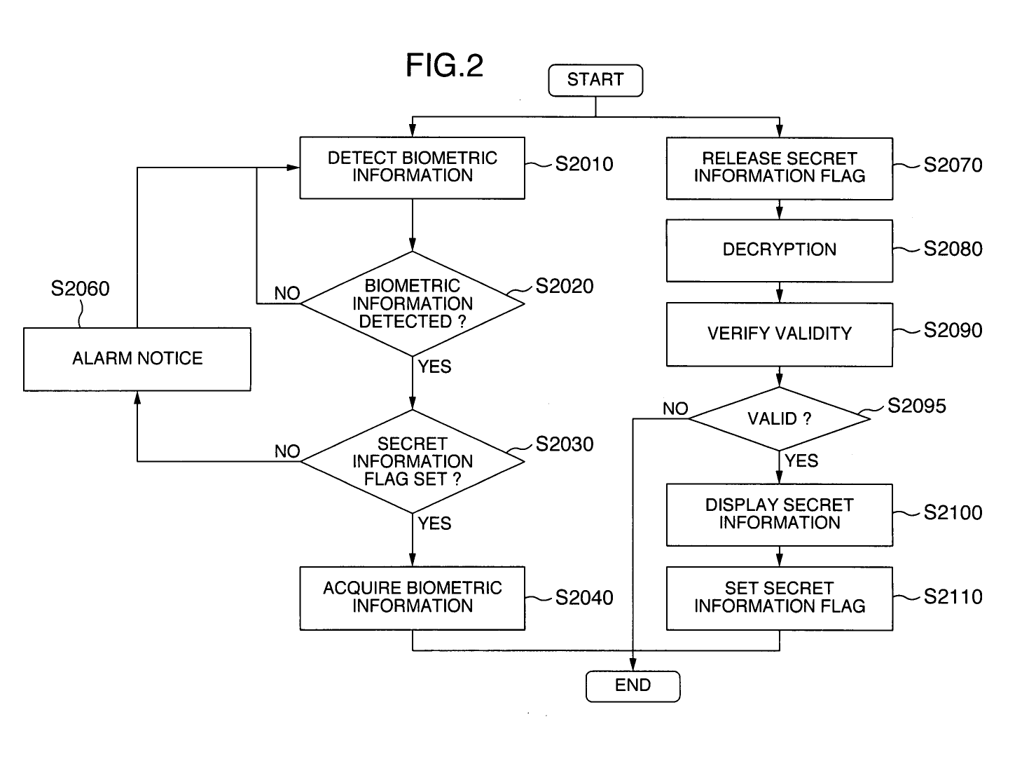

FIG. 2 is a flow chart schematically illustrating an operation of the embodiment. Each Step will now be described.

As biometric authentication starts, the biometric information sensor 100 releases a secret information flag loaded in an inner holding unit (e.g., a register) (Step S2070). The secret information flag is a flag for judging whether the secret information has been presented to a user. The released state of this flag indicates that the secret information has not been presented to the user, whereas a set state indicates that the secret information has been presented by the user. At the same time, the biometric information detection unit 110 of the biometric information sensor 100 starts detecting biometric information (Step S2010).

First, processes after Step S2070 will be described. The decryption unit 125 reads the encrypted secret information 140 from PC 135, reads the decryption key 130 from the storage unit, decrypts the secret information 140 by using the decryption key 130, and temporarily stores the secret information in a work memory or the like (Step S2080).

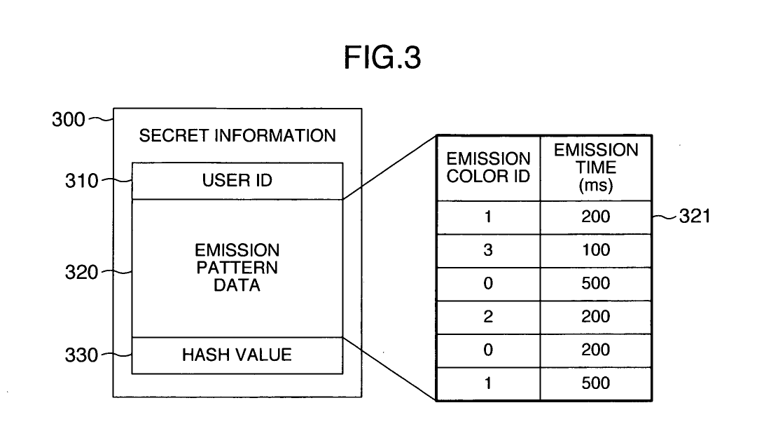

FIG. 3 is a diagram showing an example of the data structure of secret information before encryption. The encrypted secret information 140 is generated by encrypting secret information 300. The secret information 300 includes a user ID 310, emission pattern data 320 to be presented to a user, and a hash value 330 for the user ID and emission pattern data. The user ID 310 and hash value 330 are not essential. In this embodiment, the emission pattern is used as the secret information to be presented to a user, by way of example and not limitative. For example, as shown in a table 321 of FIG. 3, the emission pattern data is constituted of emission color IDs and emission time of each color. If an emission color ID is “0”, it means an extinguished state, and IDs of “1” to “3” represent emission colors. When Step S2080 is completed, the secret information 300 is temporarily stored. In the example shown in FIG. 3, color of the emission color ID “1” is irradiated for 200 ms, thereafter color of the emission color ID “3” is irradiated for 100 ms, and then color of the emission color ID “0” is irradiated for 500 ms. It is preferable that one piece of emission pattern data is registered for each user (user ID) independently from the biometric information, by way of example and not limitative.

The validity verification unit 120 generates a hash value from the user ID 310 of the user having the secret information and the emission pattern data 320 by using a hash function (Step S2090). If the generated hash value is the same as the hash value 330 of the secret information 300, it is judged that the secret information is valid, to thereafter advance to the next Step, whereas in other cases (e.g., if not coincident), the process is terminated (Step 2095).

Next, the secret information display unit 105 displays an emission pattern of three colors in accordance with the emission pattern data 320 of the secret information 300 (Step S2100). Thereafter, the secret information flag held in the holding unit in the biometric information sensor 100 is set to thereafter terminate the process (Step S2110). Validity of the emission pattern is confirmed by the user. Namely, the biometric information sensor 100 displays the emission pattern to the user in order to guarantee validity of the biometric information sensor 100 itself.

When the emission pattern is displayed on the secret information display unit 105, PC 135 may display a confirmation message of whether the emission pattern is valid on the display unit of PC 135, to receive an input indicating validity of the emission pattern from the user via the input device of PC 135. In this case, when the emission pattern is displayed on the secret information display unit 105, PC 135 may receive a notice from the secret information display unit 105, may display the confirmation message in response to the notice, and may notify the biometric information sensor 100 of reception of an input indicating validity of the emission pattern from the user.

Processes to be executed after Step S2010 are as follows. If the biometric information detection unit 110 detects biometric secret information, the flow advances to the next Step, whereas if not, the flow returns to Step S2010 to repeat the detection process (Step S2020).

The biometric information sensor 100 checks the secret information flag (predetermined value) held therein, and if the secret information flag is set, the flow advances to the next Step S2040, whereas if not, the flow advances to Step S2060 (Step S2030). If the secret information flag is set, the biometric information acquisition unit 115 acquires biometric information, and transmits the acquired biometric information to the collation unit 145 (Step S2040) to thereafter terminate the process. If the secret information flag has been reset, the alarm notice unit 107 issues an alarm sound (Step 2060) to thereafter return to Step S2010 to repeat the above-described processes. Namely, the emission pattern of each user (user ID) and biometric information are managed not by one table but by different tables, and checking the secret information of the biometric information sensor 100 by the user and authenticating the biometric information of the user by the biometric information sensor 100 are combined with involvement of the secret information flag.

The collation unit 145 receives the user ID and biometric information from the biometric information acquisition unit 115, reads biometric information corresponding to the user ID from the templates 150 by using the user ID, and collates the biometric information from the biometric information acquisition unit 115 with the biometric information in the template 150. Namely, it is compared whether the biometric information from the biometric information acquisition unit 115 corresponds (e.g. coincides with) the biometric information in the template 150. If both information corresponds, the collation unit 145 judges as a collation success to execute a transaction requested from the user, whereas if collation fails, the request from the user is rejected. The processor of PC 135 permits the user to use PC 135 in the case of the collation success.

The secret information display unit 105 is preferably disposed near the biometric information detection unit 110. For example, the secret information display unit 105 is preferably disposed adjacent to the up, down, right and left of the biometric information detection unit 110. The secret information is preferably registered not for each biometric information but for each user, i.e., for each user ID. Namely, it is preferable that secret information is registered for each user.

PC 135 and biometric information sensor 100 may be a single unified apparatus. Secret information may be stored in the storage unit of the biometric information sensor 100 instead of the storage unit in PC 135. If secret information is stored in the storage unit of the biometric sensor 100, the secret information may not be encrypted. The collation unit 145 and templates 150 may be disposed in another computer (e.g., a server) connected to PC 135 via a network, instead of being disposed in PC 135.

The technical idea of the present invention is applicable not only to PC but also to an automatic teller machine (ATM) and a lock apparatus. The technical idea of the present invention is applicable not only to biometric information but also to password.

The present invention is applicable to a biometric authentication system which performs user authentication through positive presentation of biometric information from a user. For example, the present invention is applicable to biometric authentication techniques including a motion (behavior) presenting a portion of a body to the biometric authentication system, such as finger print authentication, vein pattern authentication, and palm authentication. The present invention is also applicable to biometric authentication techniques based on a motion of a user, voice (voice print) authentication and dynamic signature authentication. The present invention is applicable to biometric authentication techniques such as face authentication not requiring specific motions for presenting biometric information, if a user has means capable of instructing explicitly to photograph the face. The present invention is applicable to arbitrary applications for performing user authentication by utilizing these biometric authentication techniques. For example, the present invention is applicable to information access control of a network in a company, user confirmation at an Internet banking system and ATM, login to a Web site for participants, individual authentication for entrance to a protected area, login to a personal computer, entrance/exit management for important facilities and rooms, and the like.

It should be further understood by those skilled in the art that although the foregoing description has been made on embodiments of the invention, the invention is not limited thereto and various changes and modifications may be made without departing from the spirit of the invention and the scope of the appended claims.

1. An information processing apparatus for authenticating a user by utilizing biometric information of said user including physical or behavioral features, comprising:
a unit for encrypting secret information of said user and registering the encrypted secret information, said secret information being able to be known by said user;
a unit for decrypting said encrypted secret information; and
a unit for presenting said decrypted secret information to said user.

2. The information processing apparatus according to claim 1, further comprising:
a unit for verifying validity of said secret information,
wherein said presenting unit presents said secret information if validity of said secret information is verified.

3. The information processing apparatus according to claim 1, further comprising:
a sensor unit for acquiring said biometric information,
wherein said decrypting unit and said presenting unit are included in said sensor unit.

4. The information processing apparatus according to claim 2, further comprising:
a sensor unit for acquiring said biometric information,
wherein said verifying unit is included in said sensor unit.

5. The information processing apparatus according to claim 1, further comprising:
a unit for issuing an alarm to said user when said user enters said biometric information before said secret information of said user is presented.

6. The information processing apparatus according to claim 1, wherein said secret information is different for each user registered in the information processing apparatus.

7. The information processing apparatus according to claim 1, wherein said secret information is an emission pattern of light of a plurality of different colors.

8. The information processing apparatus according to claim 1, wherein said decrypting unit has a high tamper resistance.

9. The information processing apparatus according to claim 2, wherein said verifying unit has a high tamper resistance.

10. An information processing apparatus equipped with an authentication function for a user, comprising:
a storage unit for storing authentication information of said user;
an input unit for inputting authentication information of said user; and
a collation unit for collating said authentication information from said input unit in accordance with said authentication information in said storage unit,
wherein:
said storage unit stores secret information said user can know; and
said input unit presents said secret information in said storage unit to said user before said authentication information is received from said user.

11. The information processing apparatus according to claim 10, wherein:
said input unit includes a detection unit for detecting said authentication information of said user and an output unit for outputting said secret information;
said detection unit sets a predetermined value when said output device outputs said secret information; and
when said authentication information of said user is detected, said detection unit judges whether said predetermined value is set, and when said predetermined value is not set, an alarm is issued from an alarm unit.

12. The information processing apparatus according to claim 10, wherein:
said storage unit stores said secret information encrypted; and
said input unit includes a decryption unit for decrypting said encrypted secret information.

13. The information processing apparatus according to claim 10, wherein:
said secret information includes a user ID, output pattern data from said input unit and a hash value for said user ID and said output pattern data;
said input unit includes a verification unit for generating a hash value for said user ID and said output pattern data in said secret information, and verifying said generated hash value in accordance with said hash value in said secret information; and
said input unit outputs said secret information when verification of said hash value succeeds.

14. The information processing apparatus according to claim 10, wherein said secret information is used for the user to judge whether said input unit or said information processing apparatus is valid, before said user inputs said authentication information to said input unit.

15. The information processing apparatus according to claim 10, wherein said input unit presents said secret information to said user in order to guarantee said user that said input unit or said information processing apparatus is valid, before said user inputs said authentication information to said input unit.

16. The information processing apparatus according to claim 10, wherein said storage unit stores one piece of said secret information for each user independently from said authentication information.
